(19) United States
(12) Patent Application Publication
(10) Pub. No.: US 2018/0173234 A1
(43) Pub. Date: Jun. 21, 2018

(54) DEVICE AND METHOD FOR BIDIRECTIONAL COMMUNICATION BETWEEN A VEHICLE AND A PASSERBY

(71) Applicants: ALEXANDER VAN LAACK, AACHEN (DE); PETER WASSERFUHR, KOLN (DE); AXEL TORSCHMIED, KOLN (DE)

(72) Inventors: ALEXANDER VAN LAACK, AACHEN (DE); PETER WASSERFUHR, KOLN (DE); AXEL TORSCHMIED, KOLN (DE)

(21) Appl. No.: 15/848,860

(22) Filed: Dec. 20, 2017

(30) Foreign Application Priority Data
Dec. 20, 2016 (DE) 10 2016 125 005.8

(51) Int. Cl. G05D 1/00; G06K 9/00; G10L 15/22; H04R 1/40

(52) U.S. Cl. CPC G05D 1/0088; G06K 9/00791; G06K 9/00335; H04L 67/12; H04R 1/403; H04R 1/406; G10L 15/22

(57) ABSTRACT

A device and method for a vehicle to provide a bidirectional communication between the vehicle and at least one passerby. The device comprises a sensor for detecting a passersby near the vehicle and an array arranged on the vehicle and formed by a plurality of loudspeakers and a plurality of microphones for providing an acoustical beamforming focused in a predetermined region around the position of a detected passerby for the sending of acoustical signals to the passerby and for the receiving of acoustical information from the passerby. The device also has a computer-based recognition module coupled to the sensor and the array for recognizing gestures and/or acoustical messages from the passerby. An action of the vehicle, such as reproducing an acoustical signal and/or receiving a visual or acoustical message from the passerby, is performed based upon an identified passerby gesture and/or an identified acoustical message from the passerby.

### CROSS REFERENCE TO RELATED APPLICATION

This U.S. utility patent application claims the benefit of German patent application No. 10 2016 125 005.8, filed Dec. 20, 2016, the contents of which are incorporated herein by reference in its entirety.

### BACKGROUND

Traditional substantially autonomously driving vehicles have many sensors such as distance sensors or cameras for detecting the vehicle's surroundings. The sensor detection of the vehicle's surroundings is used for the maneuvering of the vehicle and for recognizing changes in the traffic, for example, in order to react to an impending collision. Known systems for detection of the surroundings have the ability to distinguish between static and dynamic objects of the vehicle's surroundings, so that the movement of the vehicle can be adapted appropriately to the vehicle's surroundings. When a passerby, such as a pedestrian, arrives in the detection zone of the vehicle's sensors, the passerby may be recognized by the vehicle as being a dynamic object, yet neither the vehicle nor the passerby is able to identify which action or reaction, such as stopping or turning, is to be expected from the other. This may result in a misinterpretation of the next action on the part of both, so that a fluid movement is interrupted on the part of both or an unwanted collision is caused.

Therefore, a solution is required enabling a communication between vehicles, especially autonomous vehicles, and passersby, in order to ensure a fluid course of action in traffic. However, a communication should only be made with a passerby when the situation so requires, without necessarily bringing other passersby into the communication.

In a solution known from US 2016/0167648 A1, loudspeakers which can swivel and rotate on an autonomous vehicle are employed. Driving maneuvers of the autonomously driving vehicle can be adapted on the basis of a detected vehicle's surroundings, and information addressed to the passersby is reproduced by the swiveling or rotating loudspeakers.

The orientation of the loudspeaker must be adapted by swiveling or rotating the loudspeaker for a directional signal reproduction, especially when driving past a passerby. The layouts of swiveling loudspeakers are technically complicated, maintenance intensive, and therefore costly. Furthermore, only a directional communication is possible between the autonomous vehicle and a passerby, so that the interaction between the autonomous vehicle and a passerby with a reaction of the autonomous vehicle following an action of the passerby, such as the initiation of a driving maneuver, is ruled out.

There exists a need for a low-maintenance device as well as a method for a vehicle, especially an autonomous vehicle, with which a bidirectional communication addressed to a passerby can be provided between the vehicle and the passerby.

### SUMMARY

The invention relates to a wireless communication between a vehicle, especially an autonomous vehicle, and at least one passerby in the vicinity of the vehicle. A device and a method are proposed for providing a bidirectional communication between a vehicle and at least one passerby.

The device according to the invention comprises a sensor for detecting a passersby in a position in the surroundings near the vehicle and an array arranged on the vehicle and including a plurality of loudspeakers and a plurality of microphones for providing an acoustical beamforming focused in a predetermined region around the position of a detected passerby for the sending of acoustical signals to the passerby and for the receiving of acoustical information from the passerby. According to the invention, the device furthermore comprises a computer-based recognition module, in communication with the sensor for detecting passersby, and in communication with the array of loudspeakers and microphones, for the recognition of passerby gestures and/or acoustical messages from the passerby. The computer-based recognition module is configured to perform an action of the vehicle on the basis of an identified passerby gesture and/or an identified acoustical message from the passerby. The action of the vehicle comprises a reproduction of an acoustical signal to the passerby and/or a receiving of a visual signal and/or the acoustical information from the passerby.

The plurality of loudspeakers and a plurality of microphones which together form an array arranged on the vehicle is meant each time at least two, preferably each time at least three loudspeakers or microphones.

The term autonomous vehicle includes a self-driving, computer-controlled vehicle or a vehicle driving in an autonomous operating mode, with or without passengers. Autonomous vehicle is also intended to include a vehicle operating in a semi-autonomous mode, with one or more functions being under the control and/or supervision of a human operator.

According to one aspect of the invention, the sensor for the detecting of passersby also determines position data of identified passersby in relation to the position of the vehicle. The sensor for the detecting of passersby may have a computing unit associated therewith for this purpose. On the basis of the passerby position data of an identified passerby determined by the sensor it is possible to focus an acoustical beamforming for the transmittal of acoustical signals around a region of the position of the passerby.

The acoustical beamforming includes a signal processing technique in which the array formed with the plurality of loudspeakers and the plurality of microphones is used for the directional signal transmission or for the reception of acoustical signals from a particular direction. The signal processing technique used for the acoustical beamforming may be software-controlled and/or hardware-controlled. This is accomplished with the loudspeakers and the microphones combined in a phase-controlled arrangement such that acoustical signals at certain angles experience a constructive interference, while other experience a destructive interference. The acoustical beamforming can be employed at the sending end and at the receiving end in order to achieve a spatial selectivity. Preferably, the array may have its own computing unit with software for creating an acoustical beamforming and for actuating the microphones and loudspeakers. Alternatively, the array may be coupled to, or in communication with, a corresponding computing unit. With the software-supported acoustical beamforming for the directional reproduction of acoustical signals and the receiving of acoustical signals from a focused region, the device according to the invention enables a directed bidirectional communication with a selected passerby, without other passersby not affected by the communication becoming involved in this communication.

The sensor may include at least one camera for detecting the vehicle's surroundings, being preferably a 360° camera. The sensor advantageously comprises at least two, and preferably at least three or more cameras arranged on the vehicle. Furthermore, it may be provided that further sensors are used in addition for the detection of the surroundings, such as ultrasound-based distance sensors. With the help of software of the computing unit or the computer-based recognition module, camera images and sensor data of the vehicle's surrounding may be interpreted and evaluated. Thus, for example, it is possible to detect, in addition to the detection of passerby position data, additional position data from indirect danger sources and to enter into contact in directional manner with the respective passerby based on this data. Indirect danger sources may be, for example, an accumulation of water in the road, an animal or falling objects. Furthermore, the sensor may be set up to determine position data of a passerby or a group of passersby in relation to the vehicle. It is possible to provide here a software-supported target acquisition of passersby on the basis of camera images of the at least one camera.

The computer-based recognition module is advantageously provided for an intervention in the control electronics of the vehicle, in order to perform actions of the vehicle. Since the actions of the vehicle are controlled by the computer-based recognition module, the sensor detection device provides data of the vehicle's surroundings as well as passerby position data to the computer-based recognition module for the detecting of the vehicle's surroundings. The data provided to the computer-based recognition module is evaluated and interpreted and possibly associated with a control command, which triggers an action of the vehicle. If a communication with a passerby is required, data is sent to the array in order to generate an acoustical beamforming focused around the position of the passerby.

Since the vehicle and the at least one passerby can move relative to each other, it is advantageous for the acoustical beamforming to be dynamically focusable on the basis of detected position data of the passerby. The focus region around the position of the selected passerby is adapted in consideration of the speed of the vehicle and the speed of movement of the passerby.

According to one preferred embodiment of the invention, the array formed with a plurality of loudspeakers and microphones is arranged at least in the front region of the vehicle. The plurality of loudspeakers and the plurality of microphones may be arranged alternating with each other. A virtually random arrangement of the plurality of loudspeakers and the plurality of microphones over the entire surface of the vehicle proves to be advantageous, since in this way one can ensure an optimal focusing of an acoustical beamforming in every direction of the vehicle's surroundings. Furthermore, the array formed with the plurality of loudspeakers and microphones may be designed to fade out surrounding noises outside of a region of the acoustical beamforming focused around the position of the passerby, in order to exclude passersby not affected by the communication with the vehicle from the communication. A fading out of surrounding noises can be achieved with digital filters, which are part of the software for the generating of the acoustical beamforming

The bidirectional communication provided with the device may include an exchange of information reproduced in spoken speech. Preferably, the device comprises a voice generator for the reproduction of acoustical signals through the loudspeakers of the array in the form of spoken speech. The acoustical signals reproduced in spoken speech by the vehicle through the loudspeakers of the array may be reproduced in combination with visual signals of the vehicle. For the reproduction of visual signals, an existing light installation on the vehicle may be used. However, the possibility also exists of providing additional light installations on the vehicle for the reproduction of visual signals.

According to one advantageous modification of the invention, the action triggered or performed on the basis of a recognized passerby gesture and/or a recognized acoustical message of the passerby additionally involves a second action, wherein the second action is selected from a group of actions including a notification of a passenger of the vehicle, a stopping of the vehicle, a braking of the vehicle, an acceleration of the vehicle, an avoidance maneuver of the vehicle, an exiting of an autonomous driving mode of the vehicle and a shutting off of the vehicle.

The problem is also solved by a method for vehicles, especially for autonomous vehicles, to provide a bidirectional communication between a vehicle and at least one passerby. In the method according to the invention, the surroundings of the vehicle are detected by sensors and upon detecting a passerby at a given distance from the vehicle an acoustical beamforming emanating from the vehicle for the sending of acoustical signals to the passerby and for the receiving of acoustical signals from the passerby is focused in a given region around the position of the passerby and upon recognizing a gesture and/or an acoustical message from the passerby an action of the vehicle is triggered, wherein the action of the vehicle involves at least a reproduction of an acoustical signal to the passerby and/or a receiving of a visual signal and/or the acoustical information from the passerby.

The method according to the invention is preferably employed with a device as described above.

According to one advantageous embodiment of the invention, the position of a passerby can be determined by interpreting and evaluating camera images of the vehicle's surroundings with software. The software is designed to determine position data of passersby in relation to the position of the vehicles. Preferably, software is used which enables a dynamic target acquisition of passersby who are located at a given distance from the vehicle.

The determined passerby position data is used in order to focus the acoustical beamforming in a region around the position of the passerby. The focus region of the acoustical beamforming may be chosen such that only the affected passerby can perceive an acoustical signal from the vehicle. Likewise, the focus region of the acoustical beamforming around the position of the passerby may be adjusted so that only the acoustical information from the passerby can be received at the vehicle. However, it may also be provided that a communication is required between one group of passersby and the vehicle. In this case, the focus region may be adapted according to a two-dimensional or three-dimensional extension of a group of passersby or based on a particular number of passersby of a group of passersby.

Digital filters may be used to fade out surrounding noises of a region of the acoustical beamforming focused around the position of the passerby or a group of exclude passersby, which are part of the software for generating the acoustical beamforming. The fading out of surrounding noises ensures that only the signals transmitted by the identified or focused passerby are evaluated and interpreted by the vehicle. Furthermore, the focusing of the acoustical beamforming has the advantage that passersby not affected are not drawn into the communication, since the other passersby who are outside the focus region of the acoustical beamforming cannot perceive acoustical signals of the vehicle.

The acoustical signal preferably includes information reproduced in spoken speech. The acoustical signals reproduced by the vehicle, especially the autonomous vehicle, are therefore preferably information reproduced in spoken speech. Acoustical signals may be reproduced in various languages.

The method enables a bidirectional communication between a vehicle and at least one passerby by an exchanging of acoustical signals in the form of spoken speech, while visual signals of the vehicle and gestures of the passerby may be included in the bidirectional communication.

It may be provided that several passersby independently of one another or at different distances from the vehicle need to be drawn into a bidirectional communication with the vehicle. In this case, several focus regions of the acoustical beamforming are generated corresponding to the number of passersby. For example, it may be provided that one acoustical beamforming is generated on each outer side of the vehicle, that is, front, rear, right and left.

Another possibility of involving multiple passersby includes enlarging the focus region of an acoustical beamforming.

Advantageously, the acoustical beamforming for the transmittal of acoustical signals is dynamically focused in a predetermined region around the position of the passerby on the basis of detected position data of the passerby. In this way, it is possible to dynamically equalize distance changes caused by a relative movement between a passerby and the vehicle, so that an always optimal beamforming for the bidirectional communication can be assured

According to one preferred embodiment of the invention, it may be provided that an acoustical message from the passerby and/or a gesture of the passerby is detected during and/or after an action of the vehicle. A detection of acoustical signals and/or gestures of the passerby during and/or after the action of the vehicle has the advantage that the reaction produced immediately in the passerby to an action of the vehicle can be detected and interpreted. In this way, it is possible to interrupt an action which is or has been triggered and performed on the part of the vehicle based on a wrong interpretation of a gesture or an acoustical message from the passerby or which leads to a danger situation. In this way, unwanted actions of the vehicle triggered or performed through communication mistakes or through wrong interpretations of acoustical signals or gestures can be prevented and/or corrected. For example, the tone of an acoustical signal may be considered during an interpretation of acoustical signals, especially the pitch and loudness. Alternatively or in addition, gestures may also be considered, especially the speed of movement of gestures, in order to accomplish a particular coordination with an action of the vehicle.

According to a preferred modification of the invention, it may be provided that, upon recognizing a gesture and/or an acoustical message from the passerby, a further action of the vehicle, especially of the autonomous vehicle, is additionally triggered or performed, wherein the further action is selected from a group of actions including a notification of a passenger of the vehicle, a stopping of the vehicle, a braking of the vehicle, an acceleration of the vehicle, an avoidance maneuver of the vehicle, an exiting of an autonomous driving mode of the vehicle and a shutting off of the vehicle. By the triggering or performing of a further action, it is possible to perform, in addition to the acoustical and/or visual action of the vehicle, a further action at the same time which corresponds to the action in fact articulated by the focused passerby. Thus, for example, a stopping articulated by a focused passerby is responded to with an acoustical and/or optical signal as the action of the vehicle in the direction of the focused passerby and at the same time the vehicle stops as a further action. When the software interprets a danger situation with the aid of the acoustical signal and/or the gestures of a focused passerby, it may furthermore be provided that the autonomous operating mode of the vehicle is exited and/or a passenger of the vehicle is informed of this.

### BRIEF DESCRIPTION OF THE DRAWINGS

Further details, features and advantages of designs of the invention result from the following description of embodiment examples in reference to the associated drawings.

FIG. 1 shows a schematic representation of a sample embodiment of the device for a vehicle, especially an autonomous vehicle, and schematic diagram of a first design of the display device according to the invention, and

FIG. 2 shows a flow chart of a sample embodiment of the method for a vehicle to provide a bidirectional communication between the vehicle and a passerby.

### DETAILED DESCRIPTION

Recurring features are marked with identical reference numerals in the figures.

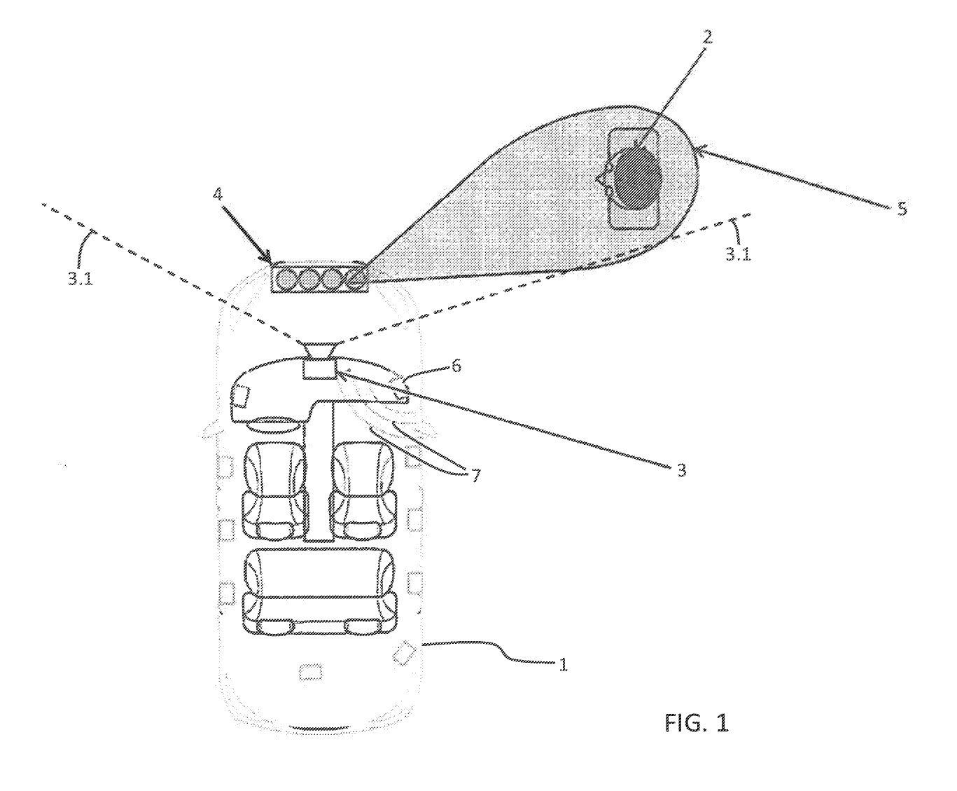

FIG. 1 a schematic representation of a sample embodiment of the device for a vehicle 1, especially an autonomous vehicle 1, to provide a bidirectional communication between the vehicle 1 and a passerby 2. The passerby 2 may be a pedestrian, or other person in the vicinity of the vehicle including, for example, person on a bicycle, scooter, motorcycle, horse, etc. The device comprises a sensor 3 for the detection of passersby 2 in a given surroundings of the vehicle 1. The sensor 3 involves a camera 3, which in the sample embodiment shown is arranged in the front region of the vehicle 1. The broken lines indicate the visual region 3.1 or viewing angle of the camera 3. The passerby 2 is located within the visual region 3.1 of the camera 3, as indicated by the broken lines, so that the camera 3 can detect the passerby 2. By means of a computer unit, which is designed to evaluate and interpret camera images of the camera 3 and which may be part of the sensor 3, position data of the passerby 2 in relation to the vehicle 1 can be determined. The computer unit may be outfitted with corresponding software for the detection and interpretation of camera images.

Furthermore, the device comprises an array 4 formed with a plurality of loudspeakers and microphones to provide an acoustical beamforming 5 focused in a given region around the position of the detected passerby 2, which is represented in FIG. 1 by a drop-shaped bubble emerging from the array 4 and surrounding the passerby 2. In the example shown, the array 4 formed with a plurality of loudspeakers and microphones is arranged in a front region of the vehicle 1. According to one advantageous embodiment, not shown, the array is arranged over the entire vehicle surface, with the plurality of microphones and the plurality of loudspeakers distributed in a regular arrangement or in an almost random arrangement over the entire structure of the vehicle 1.

The focusing of the acoustical beamforming 5 in a region around the passerby 2 is based on the passerby position data determined by the sensor 3 and it serves for the sending of acoustical signals to the passerby 2 and for the receiving of acoustical information from the passerby.

Furthermore, the device comprises a computer-based recognition module (not shown), coupled to, or in communication with, the sensor 3 and to the array 4 formed with a plurality of loudspeakers and microphones for the recognition of passerby gestures and/or acoustical messages from the passerby 2. The computer-based recognition module is configured to perform an action of the vehicle 1, on the basis of a recognized passerby gesture and/or a recognized acoustical message from the passerby 2. The action of the vehicle 1 comprises a reproduction of an acoustical signal to the passerby 2 and/or a reception of a visual signal and/or the acoustical information from the passerby 2.

The device, according to one modification, is configured such that, in response to an action triggered on the basis of a recognized passerby gesture and/or a recognized acoustical message from the passerby 2, a second action is performed in addition, wherein the second action is chosen from a group of actions including a notification of a passenger of the vehicle 1, a stopping of the vehicle 1, a braking of the vehicle 1, an acceleration of the vehicle 1, an avoidance maneuver of the vehicle 1, an exiting of an autonomous driving mode of the vehicle 1 and a shutting off of the vehicle 1. One such further action of the vehicle 1, especially the autonomous vehicle 1, during which a notification of a vehicle passenger is done, is shown in the sample embodiment of FIG. 1.

Acoustical signals of loudspeaker 6 arranged inside the vehicle and reproduced inside the vehicle 1 are indicated by lightly colored lines. It may be provided that the acoustical data 7 being acoustical messages emanating from the passerby 2 are reproduced inside the vehicle 1. In this way, it is possible to call the attention of vehicle passengers (not shown) to a situation outside the vehicle and/or to produce a communication between vehicle passengers and the passerby 2. Thanks to the acoustical beamforming 5 around the position of the passerby 2 provided with the array 4, surrounding noises outside the focused region of the acoustical beamforming 5 are faded out, so that an undisturbed communication can be assured. The acoustical signal reproduction in the direction of the passerby 2 within the acoustical beamforming 5 prevents passersby outside of the acoustical beamforming 5 from being drawn into the communication.

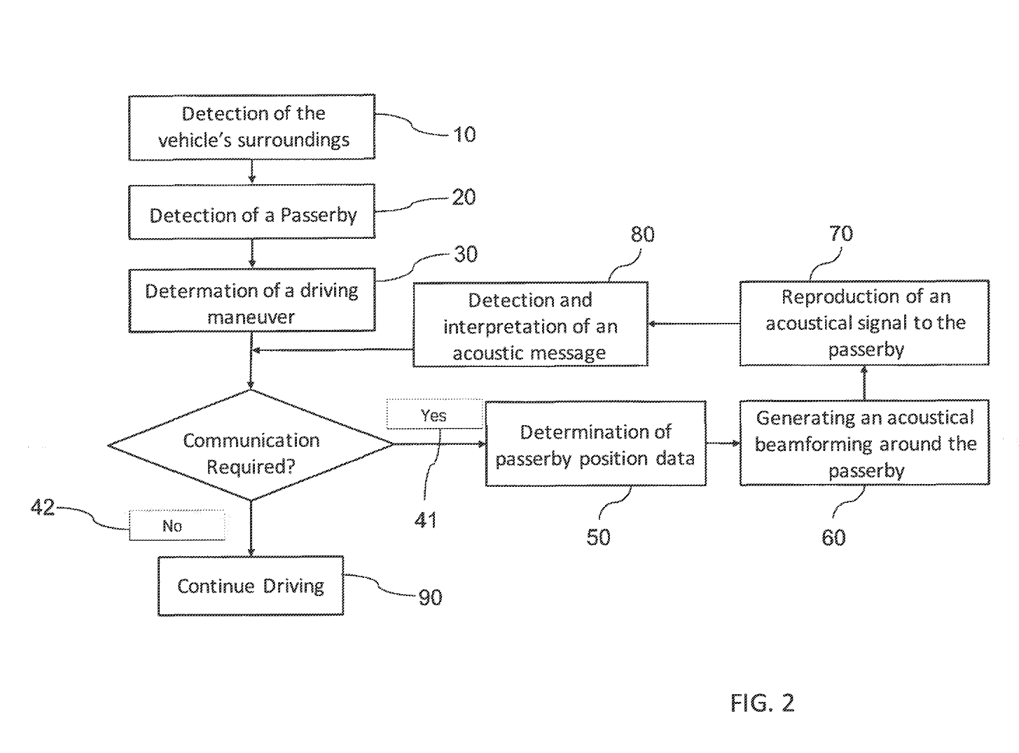

FIG. 2 shows a flow chart to explain the method for a vehicle 1, especially an autonomous vehicle 1, to provide a bidirectional communication between the vehicle 1 and a passerby 2. The method is to be used preferably with a device as shown in FIG. 1 or an embodiment of the device shown in FIG. 1. For the explanation of FIG. 2, therefore refer to the device shown in FIG. 1.

According to a preferred embodiment, the vehicle 1 is in an autonomous operating mode and can move by itself. This means that the vehicle 1 moves without direct intervention by human action. In the method for providing a bidirectional communication between the vehicle 1 and a passerby 2, first of all the surroundings of a vehicle 1 are detected by sensor, as indicated by step 10 of the method. If a passerby 2 is identified during the detecting of the vehicle's surroundings, as indicated by reference 20 in the flow chart, in the next step 30 of the method it is assessed whether an unchanged movement maneuver of the vehicle 1 is required based on the distance and/or the speed of movement and/or the direction of movement of the passerby 2 and taking in to account the movement of the vehicle 1 itself. Basically, it is to be assumed that an adapting of the movement of the vehicle 1 is required if an identified passerby 2 is already at a short distance from the vehicle 1. It may therefore be provided that a safety region is established at a given radius around the vehicle 1, in which a change in the movement of the vehicle 1 is triggered directly upon identifying a passerby 2. If an identified passerby 2 is located at a distance from the vehicle 1 that requires a communication, a decision 41 is made to establish a communication with the identified passerby 2. Furthermore, according to an alternative variant of the method not included in the flow chart, it may be provided that the decision on providing a communication with an identified passerby 2 is made based on a gesture and/or an acoustical message from the identified passerby 2. In this case, gestures can be detected by sensor or with a camera and/or acoustical signals may be detected with microphones and be evaluated and interpreted by means of software.

The next step of the method is a determination of specific position data of the passerby 2 on the basis of sensor data and/or camera images, as indicated in the flow chart by reference 50. For this, a software-supported target acquisition can be used. The determined passerby position is used in the next step 60 in order to focus an acoustical beamforming 5 emanating from the vehicle 1 for the sending of acoustical signals to the passerby 2 and for the receiving of acoustical information from the passerby 2 in a given region around the position of the passerby 2. The focus region of the acoustical beamforming 5 is chosen such that acoustical signals sent out from the vehicle 1 are only perceived by the affected passerby 2, without other passersby who are located outside the focus region of the acoustical beamforming 5 being able to perceive the acoustical signals sent out by the vehicle 1.

After reproduction of an acoustical signal 70 directed to the passerby 2, an action 80 of the vehicle 1 is triggered, while in the sample embodiment shown this involves the receiving of an acoustical information from the passerby 2 as a reaction to the signal 70 sent out by the vehicle 1. If the acoustical information from the passerby 2 does not require any further communication with the vehicle 1, the method continues with the decision 42 triggering a further action 90 of the vehicle 1, where the further action in the present example involves a driving on of the vehicle 1. The bidirectional communication can be maintained until the passerby 2 has left a safety region of the vehicle 1 or reached a given distance from the vehicle 1. Alternatively, the bidirectional communication is interrupted after a given length of time, as long as no acoustical signals affecting the vehicle 1 have been received during this length of time.

Furthermore, it may be provided that, based on a gesture and/or an acoustical message from the passerby 2, which can be detected by the vehicle 1 according to step 80 of the method, a further action of the vehicle 1 is additionally triggered, the further action being chosen from a group of actions including a notification of a passenger of the vehicle 1, a stopping of the vehicle 1, a braking of the vehicle 1, an acceleration of the vehicle 1, an avoidance maneuver of the vehicle 1, an exiting of an autonomous driving mode of the vehicle 1 and a shutting off of the vehicle 1.

If it is determined upon interpretation or recognition of a verbal reaction of a passerby 2 that a further communication with the passerby 2 is required, the bidirectional communication between the vehicle 1 and the passerby 2 will be maintained. It may be provided that the focus region of the acoustical beamforming 5 around the position of the passerby 2 is dynamically adapted when the vehicle 1 and the passerby 2 are moving relative to each other. For the dynamic adaptation of the focus region of the acoustical beamforming 5 a target acquisition for the determination of the passerby position data may be used.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Obviously, many modifications and variations of the present invention are possible in light of the above teachings and may be practiced otherwise than as specifically described while within the scope of the appended claims.

What is claimed is:

1. A device for a vehicle to provide a bidirectional communication between the vehicle and at least one passerby, comprising:
a sensor for detecting a passersby in a position near the vehicle,
an array arranged on the vehicle and including a plurality of loudspeakers and a plurality of microphones, for providing an acoustical beamforming, focused in a predetermined region around the position of the passerby, and for sending acoustical signals to the passerby and for receiving acoustical information from the passerby,
a computer-based recognition module in communication with the sensor for detecting the passerby, and in communication with the array for recognizing a gesture and/or an acoustical message in the acoustical information from the passerby,
wherein the computer-based recognition module is configured to cause an action of the vehicle on the basis of an identified gesture and/or an identified acoustical message from the passerby, and
wherein the action of the vehicle comprises a reproduction of an acoustical signal to the passerby and/or a receiving of a visual signal and/or the acoustical information from the passerby.

2. The device according to claim 1, wherein the vehicle is an autonomous vehicle.

3. The device according to claim 1, wherein the sensor for detecting the passersby comprises at least one camera.

4. The device according to claim 1, wherein the sensor for detecting the passersby is configured to determine position data of the passerby in relation to the vehicle.

5. The device according to claim 1, wherein the acoustical beamforming is dynamically focusable on the basis of a detected position data of the passerby.

6. The device according to claim 1, wherein the array formed with a plurality of loudspeakers and a plurality of microphones is arranged at least in the front region of the vehicle.

7. The device according to claim 1, wherein the array formed with a plurality of loudspeakers and a plurality of microphones is designed to fade out surrounding noises outside of a region of the acoustical beamforming focused around the position of the passerby.

8. The device according to claim 1, wherein the action triggered on the basis of a recognized passerby gesture and/or a recognized acoustical message of the passerby additionally involves a second action, wherein the second action is selected from a group of actions including a notification of a passenger of the vehicle, a stopping of the vehicle, a braking of the vehicle, an acceleration of the vehicle, an avoidance maneuver of the vehicle, an exiting of an autonomous driving mode of the vehicle and a shutting off of the vehicle.

9. A method for a vehicle to provide a bidirectional communication between the vehicle and at least one passerby, wherein the surroundings of the vehicle are detected by sensors and upon detecting a passerby at a given distance from the vehicle an acoustical beamforming emanating from the vehicle for the sending of acoustical signals to the passerby and for the receiving of acoustical information from the passerby is focused in a given region around the position of the passerby and upon recognizing a gesture and/or an acoustical message from the passerby, an action of the vehicle is triggered, wherein the action of the vehicle involves at least a reproduction of an acoustical signal to the passerby and/or a receiving of a visual signal and/or an acoustical message from the passerby.

10. The method as claimed in claim 9, wherein the position of a passerby is detected with at least one camera.

11. The method as claimed in claim 9, wherein the acoustical beamforming for the transmittal of acoustical signals is dynamically focused in a predetermined region around the position of the passerby on the basis of detected position data of the passerby.

12. The method as claimed in claim 9, wherein an acoustical message from the passerby and/or a gesture of the passerby is detected during and/or after an action of the vehicle.

13. The method as claimed in claim 9, wherein surrounding noises outside of a region of the acoustical beamforming focused around the position of the passerby are faded out.

14. The method as claimed in claim 9, wherein, upon recognizing a gesture and/or an acoustical message from the passerby, a further action of the vehicle is additionally triggered, wherein the further action is selected from a group of actions including a notification of a passenger of the vehicle, a stopping of the vehicle, a braking of the vehicle, an acceleration of the vehicle, an avoidance maneuver of the vehicle, an exiting of an autonomous driving mode of the vehicle and a shutting off of the vehicle.
